(19) United States
(12) Patent Application Publication
(10) Pub. No.: US 2026/0326062 A1
(43) Pub. Date: Oct. 22, 2026

(54) HYDROGEN PRODUCTION DEVICE

(71) Applicant: MITSUBISHI HEAVY INDUSTRIES, LTD., Tokyo (JP)

(72) Inventor: Yoshinori Yamasaki, Tokyo (JP)

(73) Assignee: MITSUBISHI HEAVY INDUSTRIES, LTD., Tokyo (JP)

(21) Appl. No.: 19/491,020

(22) PCT Filed: May 28, 2024
(86) PCT No.: PCT/JP2024/019518

§ 371 Date: Dec. 8, 2025

(30) Foreign Application Priority Data
Jun. 28, 2023 (JP) 2023-106187

(51) Int. Cl. B01J 8/24; C01B 3/28

(52) U.S. Cl. CPC B01J 8/24; C01B 3/28; B01J 2208/00539; B01J 2208/00752; C01B 2203/0277; C01B 2203/1241

(57) ABSTRACT

A hydrogen production device includes a reactor that produces hydrogen by thermally decomposing a hydrocarbon gas, which is a feed gas, using a catalyst including fine metallic particles. The feed gas is introduced into the reactor through a lower portion of the reactor such that a fluidized bed of the catalyst is formed inside the reactor. Inert particles serving as a fluidizing medium are mixed with the catalyst to increase fluidity of the catalyst.

### TECHNICAL FIELD

The present disclosure relates to a hydrogen production device.

### BACKGROUND ART

Techniques for producing hydrogen by thermal decomposition of methane are known. For example, the hydrogen production device disclosed in Patent Literature 1 includes a reactor accommodating a catalyst. Methane is introduced into the interior of the reactor. Within the reactor, the methane contacts the catalyst and is decomposed into hydrogen and carbon. A mixed gas composed of hydrogen, which is a product gas, and unreacted methane is discharged to the exterior of the reactor.

### CITATION LIST

### Patent Literature

Patent Literature 1: JP2019-73411A

### SUMMARY OF INVENTION

### Technical Problem

The catalyst is, for example, a metal such as iron. In such a case, for example, at the time of startup of the hydrogen production device, particles of the catalyst may be fused with each other as the temperature of the reactor increases. The hydrogen production device is thus required to suppress fusion between particles of catalyst.

### Solution to Problem

In accordance with one aspect of the present disclosure, a hydrogen production device includes a reactor that produces hydrogen by thermally decomposing a hydrocarbon gas, which is a feed gas, using a catalyst including fine metallic particles. The feed gas is introduced into the reactor through a lower portion of the reactor such that a fluidized bed of the catalyst is formed inside the reactor. Inert particles serving as a fluidizing medium are mixed with the catalyst to increase fluidity of the catalyst.

### BRIEF DESCRIPTION OF DRAWINGS

FIG. 1 is a schematic diagram illustrating a hydrogen production device according to a first embodiment.

FIG. 2 is a block diagram showing an electrical configuration of the hydrogen production device shown in FIG. 1.

FIG. 3 is a schematic diagram illustrating a hydrogen production device according to a second embodiment.

### DESCRIPTION OF EMBODIMENTS

### First Embodiment

A hydrogen production device according to a first embodiment will now be described.

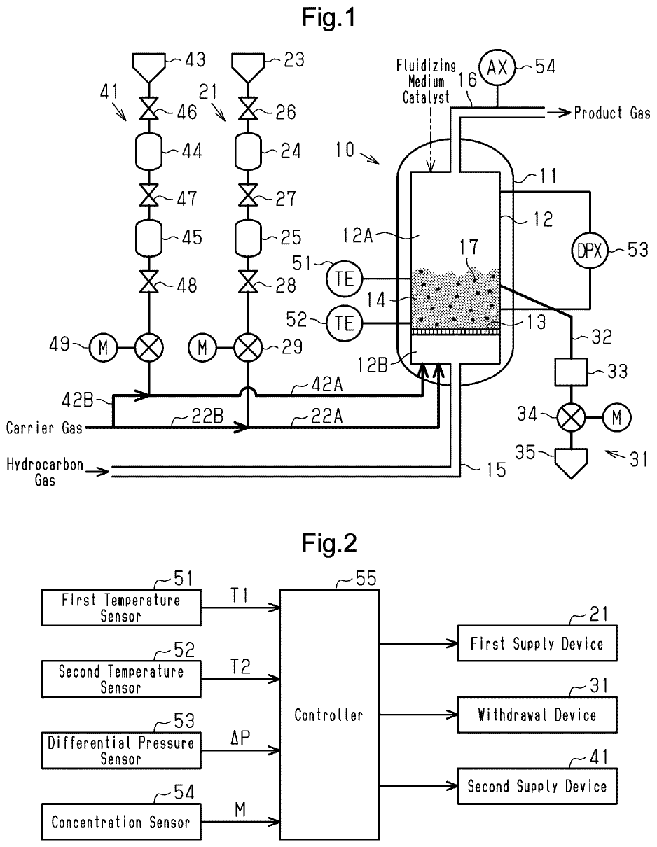

As shown in FIG. 1, a hydrogen production device 10 includes a pressure vessel 11 and a reactor 12. Each of the pressure vessel II and the reactor 12 has a tubular shape having a circular cross-sectional shape and extends in the vertical direction. The interior of the pressure vessel 11 is maintained at a specified pressure. The pressure is, for example, higher than atmospheric pressure. The reactor 12 is accommodated in the pressure vessel 11 in a non-contact state. The inner diameter of the reactor 12 may be constant along its entire length.

A distributor 13 is provided inside the reactor 12. The distributor 13 has, for example, the shape of a plate extending in a direction orthogonal to the axial direction of the reactor 12, and has a large number of holes. The holes extend through the distributor 13 in the thickness direction. The distributor 13 is disposed at a position closer to the lower end of the reactor 12 than to the center position in the axial direction of the reactor 12. The distributor 13 partitions the interior of the reactor 12 into two spaces, i.e., upper and lower spaces. The upper space is a reaction chamber 12A, and the lower space is a windbox 12B. The reaction chamber 12A and the windbox 12B communicate with each other via the holes of the distributor 13.

A catalyst 14 is deposited on the upper surface of the distributor 13. In other words, the inside of the reaction chamber 12A is filled with the catalyst 14 up to a specified deposition height with respect to the distributor 13. The upper surface of the distributor 13 is a surface that faces the reaction chamber 12A. The catalyst 14 is composed of, for example, fine solid particles of iron (Fe) or fine metallic particles mainly composed of iron. The catalyst 14 is heated by a heating device. The heating device may be, for example, a heater, or a jacket through which exhaust gas or steam flows.

An inlet pipe 15 is connected to the lower end of the reactor 12. The inlet pipe 15 extends through the lower end of the pressure vessel 11. The inlet pipe 15 is a gas passage for introducing feed gas into the reactor 12. The feed gas is a hydrocarbon gas. The hydrocarbon gas is, for example, methane or a gas mainly composed of methane. The hydrocarbon gas is brought into contact with the catalyst 14 in the reactor 12 and decomposed into hydrogen and carbon. The carbon is in powder form.

An outlet pipe 16 is connected to the upper end of the reactor 12. The outlet pipe 16 extends through the upper end of the pressure vessel 11. The outlet pipe 16 is a gas passage for discharging product gas to the exterior of the reactor 12. The product gas is a gas produced inside the reactor 12, and is a mixed gas of hydrogen generated by thermal decomposition and unreacted hydrocarbon.

The feed gas is supplied to the reaction chamber 12A through the windbox 12B and the distributor 13. The feed gas is uniformly distributed and diffused by the distributor 13. Thus, the feed gas uniformly flows into the reaction chamber 12A from below. When the feed gas is blown upward from below into the reaction chamber 12A. the catalyst 14, which includes solid particles, becomes suspended to a certain height and moves vigorously. In other words, a fluidized bed, which is a layer of vigorously moving catalyst 14, is formed. Fluidization of the catalyst 14 enables favorable mixing of the catalyst 14 with the feed gas, thereby promoting contact between the catalyst 14 and the feed gas. As a result, thermal decomposition of the feed gas by the catalyst 14 is promoted.

The reactor 12 is a fluidized-bed reaction vessel. The catalyst 14 serves as a fluidizing medium. The feed gas is a fluidizing gas for fluidizing the catalyst 14.

### <Reaction Temperature>

When producing hydrogen, the reactor 12, and hence the catalyst 14 therein, is heated to a specified reaction temperature. The reaction temperature is a temperature at which the thermal decomposition reaction of the feed gas by the catalyst 14 proceeds efficiently. The reaction temperature is set, depending on product specifications or the like, to a value within a specified temperature range. The lower limit of the temperature range is set, for example, based on the initiation temperature of thermal decomposition. The upper limit of the temperature range is set, for example, based on the heat resistance of the reactor 12.

When the reaction temperature is lower than the lower limit of the temperature range, the thermal decomposition reaction of the feed gas may not proceed. This is because, when the reaction temperature is lower than the initiation temperature of thermal decomposition, the ability of the catalyst 14 to decompose the feed gas is not activated. The higher the reaction temperature, the more the thermal decomposition of the feed gas progresses. However, when the reaction temperature exceeds the upper limit of the temperature range, the reliability of the reactor 12 may not be ensured.

### <Relationship Between Pressure of the Reactor 12 and Amount of Hydrogen Produced>

Next, the relationship between the pressure of the reactor 12 and the amount of hydrogen produced will be described. The pressure refers to the internal pressure of the reactor 12. The internal pressure of the reactor 12 corresponds to the pressure of the feed gas supplied to the reactor 12. Here, the case in which the feed gas is methane will be described by way of example.

The thermal decomposition reaction of methane is represented by the following equation (1).

CH4→2H₂+C . . . (1)

When methane thermal decomposition is in a state of reaction equilibrium, the following equation (2) holds regardless of the pressure of the reactor 12:

P_{H2}²/P_{CH4}=Constant . . . (2)

Here, P_{H2}² denotes the partial pressure of hydrogen inside the reactor 12, corresponding to the amount of hydrogen generated. P_{CH4} denotes the partial pressure of methane inside the reactor 12, corresponding to the pressure of methane supplied to the reactor 12. The symbol “/” denotes division.

If the pressure of the reactor 12, i.e., the supply pressure of methane, is increased by four times, the partial pressure of methane and the partial pressure of hydrogen also appear to be increased by four times. However, according to the equation (2) above, the partial pressure of hydrogen is doubled. In other words, the amount of hydrogen produced is reduced to ½ of that before the pressure increase.

Accordingly, when the pressure of the reactor 12, that is, the supply pressure of methane, is increased, the amount of hydrogen produced decreases relative to the amount produced before the pressure increase, in accordance with the reaction equilibrium. In other words, the conversion rate of methane decreases. The conversion rate represents the degree of progress of the thermal decomposition reaction in the reactor 12 and indicates the ratio of conversion of methane, which is the feed gas, into hydrogen. The pressure of the reactor 12, that is, the supply pressure of methane, is set according to product specifications or the like.

### <Supply and Discharge of the Catalyst 14>

During operation of the hydrogen production device 10, the activity of the catalyst 14 gradually decreases as the thermal decomposition reaction proceeds. Accordingly, in order to maintain the decomposition rate of the feed gas, fresh catalyst 14 must be supplied to the reactor 12 while catalyst 14 having reduced activity is withdrawn from the reactor 12. Catalyst 14 having reduced activity includes deactivated catalyst 14. Deactivation refers to loss of the activity of the catalyst 14 such that the thermal decomposition reaction of the feed gas no longer proceeds. The decomposition rate refers to the proportion of the feed gas decomposed within a certain period of time by the action of the catalyst 14.

Catalyst 14 having reduced activity has a smaller particle size and density compared with fresh catalyst 14. As the particle size and particle density decrease, the terminal velocity of particles of the catalyst 14 having reduced activity becomes lower than the superficial velocity. Accordingly, catalyst 14 having reduced activity is generally carried out of the reactor 12 together with the product gas through the outlet pipe 16. The superficial velocity is the flow velocity of the feed gas calculated on the assumption that the catalyst 14, which includes the packed particles, is not present in the reactor 12. The terminal velocity is the velocity at which the upward drag force of the feed gas on a particle balances the downward gravitational force on the particle.

However, some of the catalyst 14 having reduced activity remains inside the reactor 12 due to binding with carbon generated by thermal decomposition of the feed gas. This is because the particle size or the particle density of the catalyst 14 having reduced activity increases as a result of combining with the generated carbon. Therefore, it is necessary to discharge the catalyst 14 having reduced activity to the exterior of the reactor 12. Accordingly, the present embodiment employs the hydrogen production device 10 having the following configuration.

### <Configuration for Supplying Catalyst 14>

As shown in FIG. 1, the hydrogen production device 10 includes a first supply device 21 for supplying fresh catalyst 14 to the reactor 12. The first supply device 21 is, for example, a lock hopper system. The first supply device 21 is provided in a first supply path 22A. The first supply path 22A is a path for supplying fresh catalyst 14 to the reactor 12, and is formed of piping, for example. The first supply path 22A extends through the lower end of the pressure vessel 11 and is connected to the lower end of the reactor 12.

The first supply device 21 includes a first receiving hopper 23, a first intermediate hopper 24, and a first supply hopper 25. The first supply hopper 25, the first intermediate hopper 24, and the first receiving hopper 23 are arranged in that order from the side close to the reactor 12. The first intermediate hopper 24 is located between the first receiving hopper 23 and the first supply hopper 25. Each hopper is a device that temporarily stores fresh catalyst 14.

The first receiving hopper 23 receives fresh catalyst 14 supplied from the outside and temporarily stores the received fresh catalyst 14. The pressure of the first receiving hopper 23 is maintained at, for example, atmospheric pressure.

A pressure-regulating pipe is connected to the first intermediate hopper 24 via a valve. By introducing high-pressure gas into the first intermediate hopper 24 through the pipe, the internal pressure of the first intermediate hopper 24 can be raised to a pressure higher than atmospheric pressure. By releasing the pressure inside the first intermediate hopper 24 through the pipe, the internal pressure of the first intermediate hopper 24 can be reduced to atmospheric pressure. The high-pressure gas is an inert gas such as nitrogen or argon.

The pressure of the first supply hopper 25 is constantly maintained at a pressure higher than the pressure of the reactor 12. This serves, for example, to prevent backflow of the catalyst 14.

A first shutoff valve 26 is provided in the first supply path 22A between the first receiving hopper 23 and the first intermediate hopper 24. The first shutoff valve 26 opens and closes the first supply path 22A between the first receiving hopper 23 and the first intermediate hopper 24.

A second shutoff valve 27 is provided in the first supply path 22A between the first intermediate hopper 24 and the first supply hopper 25. The second shutoff valve 27 opens and closes the first supply path 22A between the first intermediate hopper 24 and the first supply hopper 25.

A third shutoff valve 28 and a first electric valve 29 are provided in the first supply path 22A between the first supply hopper 25 and the reactor 12. The third shutoff valve 28 is provided in the first supply path 22A between the first supply hopper 25 and the first electric valve 29. The third shutoff valve 28 opens and closes the first supply path 22A between the first supply hopper 25 and the first electric valve 29.

The first electric valve 29 is, for example, a rotary valve. The first electric valve 29 includes a motor and a rotor that rotates by being driven by the motor. By controlling the rotation speed of the rotor, the discharge amount of the catalyst 14, which includes fine solid particles, can be controlled.

A second supply path 22B is connected to the first supply path 22A between the first electric valve 29 and the reactor 12. The second supply path 22B is a path for supplying a carrier gas to the first supply path 22A between the first supply hopper 25 and the reactor 12, and is formed, for example, of piping. The carrier gas is a gas for carrying the catalyst 14 in the first supply path 22A between the first electric valve 29 and the reactor 12 into the reactor 12. The carrier gas is an inert gas such as nitrogen or argon. The catalyst 14 moves together with the flow of the carrier gas.

### <Configuration for Discharging Catalyst 14>

As shown in FIG. 1. the hydrogen production device 10 includes a withdrawal device 31 for withdrawing catalyst 14 having reduced activity from the reactor 12. The withdrawal device 31 is provided in a withdrawal path 32 for the catalyst 14. The withdrawal path 32 is a path for withdrawing catalyst 14 having reduced activity to the exterior of the reactor 12, and is formed of piping, for example. A first end of the withdrawal path 32 is connected to a portion of the reactor 12 that corresponds to an upper portion of the fluidized bed of the catalyst 14. The upper portion is a portion of the fluidized bed on the side far from the distributor 13 in the axial direction of the reactor 12.

The withdrawal device 31 includes a cooler 33, a second electric valve 34, and a withdrawal hopper 35. The cooler 33, the second electric valve 34, and the withdrawal hopper 35 are arranged in that order from the side close to the reactor 12. The second electric valve 34 is located between the cooler 33 and the withdrawal hopper 35. The withdrawal hopper 35 is connected to a second end of the withdrawal path 32. The second end is an end of the withdrawal path 32 opposite to the first end.

The cooler 33 cools the catalyst 14 having reduced activity, which has been withdrawn from the reactor 12. The second electric valve 34 is, for example, a rotary valve. The second electric valve 34 includes a motor and a rotor that rotates by being driven by the motor. By controlling the rotation speed of the rotor, the discharge amount of the catalyst 14, which includes fine solid particles, can be controlled. The withdrawal hopper 35 continuously withdraws the catalyst 14 having reduced activity, and temporarily stores the withdrawn catalyst 14.

### <Fusion of Catalyst 14>

The catalyst 14 includes, for example, iron or fine solid particles mainly composed of iron. Accordingly, when only the catalyst 14 is accommodated in the reactor 12, the following concern may arise. At startup of the hydrogen production device 10, as the temperature of the reactor 12 rises, particles of the catalyst 14 are fused together, thereby impairing the flow of the catalyst 14. Further, during operation of the hydrogen production device 10, the physical properties of the catalyst 14 gradually change as the thermal decomposition reaction proceeds. As a result, there is a concern that the stability of the flow of the catalyst 14 changes. The physical properties of the catalyst 14 include the particle size and density of the catalyst 14.

Accordingly, the present embodiment employs the hydrogen production device 10 having the following configuration. As shown in FIG. 1, the catalyst 14 is mixed with a fluidizing medium 17. The fluidizing medium 17 improves the fluidity of the catalyst 14. The fluidizing medium 17 includes fine solid particles, for example, inert particles of silicon.

### <Configuration for Supplying the Fluidizing Medium 17>

As shown in FIG. 1, the hydrogen production device 10 includes a second supply device 41 for supplying the fluidizing medium 17 to the reactor 12. The second supply device 41 is provided in a third supply path 42A. The third supply path 42A is a path for supplying the fluidizing medium 17 to the reactor 12, and is formed of piping, for example. The third supply path 42A extends through the lower end of the pressure vessel 11 and is connected to the lower end of the reactor 12.

The second supply device 41 is, for example, a lock hopper system, and has the same configuration as the first supply device 21. Specifically, the second supply device 41 includes a second receiving hopper 43, a second intermediate hopper 44, and a second supply hopper 45. The second supply hopper 45, the second intermediate hopper 44, and the second receiving hopper 43 are arranged in that order from the side close to the reactor 12. The second intermediate hopper 44 is located between the second receiving hopper 43 and the second supply hopper 45.

The second receiving hopper 43 receives the fluidizing medium 17 supplied from the outside and temporarily stores the received fluidizing medium 17. The pressure of the second receiving hopper 43 is maintained at, for example, atmospheric pressure.

A pressure-regulating pipe is connected to the second intermediate hopper 44 via a valve. By introducing high-pressure gas into the second intermediate hopper 44 through the pipe, the internal pressure of the second intermediate hopper 44 can be raised to a pressure higher than atmospheric pressure. By releasing the pressure inside the second intermediate hopper 44 through the pipe, the internal pressure of the second intermediate hopper 44 can be reduced to atmospheric pressure. The high-pressure gas is an inert gas such as nitrogen or argon.

The pressure of the second supply hopper 45 is constantly maintained at a pressure higher than the pressure of the reactor 12. This serves, for example, to prevent backflow of the fluidizing medium 17.

A fourth shutoff valve 46 is provided in the third supply path 42A between the second receiving hopper 43 and the second intermediate hopper 44. The fourth shutoff valve 46 opens and closes the third supply path 42A between the second receiving hopper 43 and the second intermediate hopper 44.

A fifth shutoff valve 47 is provided in the third supply path 42A between the second intermediate hopper 44 and the second supply hopper 45. The fifth shutoff valve 47 opens and closes the third supply path 42A between the second intermediate hopper 44 and the second supply hopper 45.

A sixth shutoff valve 48 and a third electric valve 49 are provided in the third supply path 42A between the second supply hopper 45 and the reactor 12. The sixth shutoff valve 48 is provided in the third supply path 42A between the second supply hopper 45 and the third electric valve 49. The sixth shutoff valve 48 opens and closes the third supply path 42A between the second supply hopper 45 and the third electric valve 49.

The third electric valve 49 is, for example, a rotary valve. The third electric valve 49 includes a motor and a rotor that rotates by being driven by the motor. By controlling the rotation speed of the rotor, the discharge amount of the catalyst 14, which includes fine solid particles, can be controlled.

A fourth supply path 42B, which branches from the second supply path 22B, is connected to the third supply path 42A between the third electric valve 49 and the reactor 12. The fourth supply path 42B is a path for supplying carrier gas to the third supply path 42A between the third electric valve 49 and the reactor 12, and is formed, for example, of piping. The carrier gas is a gas for carrying the fluidizing medium 17 in the third supply path 42A between the third electric valve 49 and the reactor 12 into the reactor 12. The fluidizing medium 17 moves together with the flow of the carrier gas.

### <Electrical Configuration of the Hydrogen Production Device 10>

The electrical configuration of the hydrogen production device 10 will now be described.

As shown in FIG. 2, the hydrogen production device 10 includes a first temperature sensor 51, a second temperature sensor 52, a differential pressure sensor 53, a concentration sensor 54, and a controller 55.

The first temperature sensor 51 is provided in the reactor 12. The first temperature sensor 51 detects a first temperature T1 of the fluidized bed of the catalyst 14. The first temperature T1 is the temperature at the upper portion of the fluidized bed.

The second temperature sensor 52 is provided in the reactor 12. The second temperature sensor 52 detects a second temperature T2 of the fluidized bed of the catalyst 14. The second temperature T2 is the temperature in a lower portion of the fluidized bed.

The differential pressure sensor 53 is provided in the reactor 12. The differential pressure sensor 53 detects a pressure difference AP between an upper portion of the reaction chamber 12A and a lower portion of the reaction chamber 12A. The upper portion of the reaction chamber 12A is a freeboard area of the reactor 12, which is out of the fluidized bed of the catalyst 14. The lower portion of the reaction chamber 12A is a portion corresponding to the fluidized bed of the catalyst 14 in the reactor 12, for example, a portion corresponding to immediately above the distributor 13.

The concentration sensor 54 is provided in the outlet pipe 16. The concentration sensor 54 detects the concentration M of hydrogen in the product gas produced by the thermal decomposition of the feed gas.

The controller 55 includes processing circuitry including any one of the following three configurations A1, A2, and A3.
A1: One or more processors that operate according to a computer program, which is software. The processor includes a central processing unit (CPU) and a memory.
A2: One or more dedicated hardware circuits such as application specific integrated circuits (ASICs) that perform at least part of various types of processes. Each ASIC includes a CPU and a memory.
A3: A hardware circuit combining configurations A1 and A2.

The memory is a medium that can be read by a computer (CPU in this example) and stores programs that describe processes or instructions for the computer. The memory includes a random-access memory (RAM) and a read-only memory (ROM). The CPU executes various kinds of control by executing programs stored in the memory at a predetermined calculation cycle.

The controller 55 controls operation of the first supply device 21, the withdrawal device 31, and the second supply device 41. The controller 55 controls supply of fresh catalyst 14 to the reactor 12 through the first supply device 21, for example, based on the detection results of the various sensors (51 to 54). The controller 55 controls withdrawal of catalyst 14 having reduced activity from the reactor 12 through the withdrawal device 31, for example, based on detection results of the various sensors (51 to 54). The controller 55 controls the supply of the fluidizing medium 17 to the reactor 12 through the second supply device 41.

### <Supply Process of Catalyst 14>

When supplying catalyst 14 to the reactor 12, the controller 55 controls the first supply device 21 in the following manner. The controller 55 first opens the first shutoff valve 26. As a result, fresh catalyst 14 stored in the first receiving hopper 23 moves into the first intermediate hopper 24 by gravity. After transferring a specified amount of catalyst 14, the controller 55 closes the first shutoff valve 26.

Next, the controller 55 introduces high-pressure gas into the first intermediate hopper 24 through the pressure-regulating pipe. As a result, the internal pressure of the first intermediate hopper 24 is increased to the same level as the pressure of the first supply hopper 25. The pressure of the first supply hopper 25 is maintained at a pressure higher than or equal to the pressure of the reactor 12. Thereafter, the controller 55 opens the second shutoff valve 27. Accordingly, the catalyst 14 in the first intermediate hopper 24 is discharged to the first supply hopper 25.

After the discharge of the catalyst 14 to the first supply hopper 25 is completed, the controller 55 closes the second shutoff valve 27 and discharges the gas in the first intermediate hopper 24 through the pressure-regulating pipe, thereby reducing the internal pressure of the first intermediate hopper 24 to atmospheric pressure. This allows the first intermediate hopper 24 to receive catalyst 14 from the first receiving hopper 23 again.

Next, the controller 55 opens the third shutoff valve 28. Accordingly, the catalyst 14 in the first supply hopper 25 is discharged to the first electric valve 29.

The controller 55 controls the first electric valve 29 so that a metered amount of the catalyst 14 is continuously discharged from the first electric valve 29. The catalyst 14 discharged from the first electric valve 29 is supplied to the reactor 12 through pneumatic conveyance. Specifically, the catalyst 14 discharged from the first electric valve 29 merges with the carrier gas at the junction of the first supply path 22A and the second supply path 22B, and is supplied to the reactor 12 together with the carrier gas. During the period in which catalyst 14 is being supplied to the reactor 12, the controller 55 opens the first shutoff valve 26. This allows the first intermediate hopper 24 to again receive catalyst 14 from the first receiving hopper 23.

When the amount of the catalyst 14 in the first supply hopper 25 decreases to the vicinity of the lower limit, the controller 55 closes the first shutoff valve 26 and introduces high-pressure gas into the first intermediate hopper 24 through the pressure-regulating pipe. As a result, the internal pressure of the first intermediate hopper 24 is increased to the same level as the pressure of the first supply hopper 25. Thereafter, the controller 55 opens the second shutoff valve 27. Accordingly, the catalyst 14 in the first intermediate hopper 24 is discharged to the first supply hopper 25.

After the discharge of the catalyst 14 to the first supply hopper 25 is completed, the controller 55 closes the second shutoff valve 27 and discharges the gas in the first intermediate hopper 24 through the pressure-regulating pipe, thereby reducing the internal pressure of the first intermediate hopper 24 to atmospheric pressure. The controller 55 opens the first shutoff valve 26 when the internal pressure of the first intermediate hopper 24 is equal to atmospheric pressure, that is, the pressure of the first receiving hopper 23. This causes the first intermediate hopper 24 to receive catalyst 14 from the first receiving hopper 23 again.

By repeatedly executing the foregoing operation, the controller 55 continuously supplies catalyst 14 to the reactor 12. The catalyst 14 is carried through pneumatic conveyance by the carrier gas into the reactor 12.

<Withdrawal of Catalyst 14 from the Reactor 12>

When withdrawing the catalyst 14 from the reactor 12, the controller 55 controls the withdrawal device 31 in the following manner. The controller 55 operates the cooler 33 and the second electric valve 34. As a result, catalyst 14 having reduced activity is withdrawn from the reactor 12. The withdrawn catalyst 14 is cooled by the cooler 33. The cooled catalyst 14 is discharged to the withdrawal hopper 35 by the second electric valve 34.

The controller 55 may execute the process of withdrawing the catalyst 14 and the process of supplying the catalyst 14 simultaneously. In this case, the discharge amount of the catalyst 14 may be the same as the supply amount of the catalyst 14 by the first supply device 21, for example. Further, the discharge rate of the catalyst 14 may be the same as the supply rate of the catalyst 14 by the first supply device 21. In this way, fluctuations in the height of the catalyst bed are moderated, allowing a uniform catalyst bed to be readily maintained. Depending on product specifications or the like, the controller 55 may execute the process of withdrawing the catalyst 14 and the process of supplying the catalyst 14 at different times.

### <Supply Process of Fluidizing Medium 17>

When supplying the fluidizing medium 17 to the reactor 12, the controller 55 controls the second supply device 41 in the same manner as the first supply device 21. Accordingly, the fluidizing medium 17 is continuously supplied to the reactor 12. The fluidizing medium 17 is carried through pneumatic conveyance by the carrier gas into the reactor 12. The supply amount of the fluidizing medium 17 is set to an appropriate amount according to product specifications or the like.

At least during startup of the hydrogen production device 10, the controller 55 supplies the fluidizing medium 17 into the reactor 12 before executing an activation process for the catalyst 14 contained in the reactor 12. The controller 55 may execute the supply process of the fluidizing medium 17 at the same time as the supply process of the catalyst 14 or the withdrawal process of the catalyst 14. Alternatively, depending on product specifications or the like, the controller 55 may execute the supply process of the fluidizing medium 17 at a time different from the supply process of the catalyst 14 or the withdrawal process of the catalyst 14. For example, the fluidizing medium 17 may be supplied into the reactor 12 after the supply of the catalyst 14 into the reactor 12 or after the withdrawal of the catalyst 14 from the reactor 12.

Also, the feed gas may be used as the carrier gas. In this case, fresh catalyst 14 and the fluidizing medium 17 are supplied to the reactor 12 by the flow of the feed gas.

### <Advantages of the First Embodiment>

The first embodiment has the following advantages.
(1-1) By mixing the fluidizing medium 17 with the catalyst 14, it is possible to suppress fusion of particles of the catalyst 14 inside the reactor 12. Accordingly, the catalyst 14 flows stably. In addition, the stability of the flow of the catalyst 14 can be ensured.
(1-2) The fluidizing medium 17 is supplied to the reactor 12 in response to, for example, supply of fresh catalyst 14 or discharge of deactivated catalyst 14. Fusion between particles of the catalyst 14 is suppressed.
(1-3) The pressure of the reactor 12 is higher than atmospheric pressure. The second supply device 41 pressurizes the fluidizing medium 17 to a pressure higher than or equal to the pressure of the reactor 12 and continuously carries the fluidizing medium 17 through pneumatic conveyance. According to this configuration, the fluidizing medium 17 is supplied to the reactor 12 through pneumatic conveyance.
(1-4) The pressure of the reactor 12 is higher than atmospheric pressure. The first supply device 21 pressurizes fresh catalyst 14 to a pressure higher than or equal to the pressure of the reactor 12 and continuously carries the fresh catalyst 14 through pneumatic conveyance. According to this configuration, the fresh catalyst 14 is supplied to the reactor 12 through pneumatic conveyance.
(1-5) Catalyst 14 having reduced activity is discharged from the reactor 12 by the withdrawal device 31. This prevents deposition of carbon generated by thermal decomposition of the feed gas in association with catalyst 14 having reduced activity inside the reactor 12.

### Second Embodiment

A hydrogen production device according to a second embodiment will now be described. The present embodiment is different from the first embodiment in the configuration of the first supply device 21, which supplies fresh catalyst 14 to the reactor 12. Therefore, the same reference numerals are given to those components that are like or the same as the corresponding components of the first embodiment and detailed explanations are omitted.

Catalyst 14 prior to activation must be activated through an activation process. The activation process involves heating the catalyst 14 prior to activation at a specified activation temperature for a specified period of time. When the catalyst 14 is activated, a thermal decomposition reaction of the feed gas occurs. The heating need only be sufficient to heat the catalyst 14 prior to activation, and may be performed by bringing the catalyst 14 into contact with a heated gas or by using a burner. The gas may be, for example, the feed gas or nitrogen.

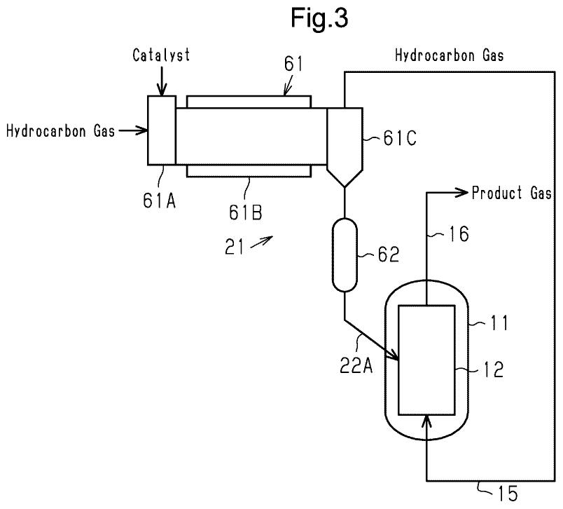

As shown in FIG. 3, the first supply device 21 includes a rotary kiln 61 and a hopper 62. The hopper 62 and the rotary kiln 61 are arranged in that order from the side close to the reactor 12. The hopper 62 has a configuration similar to that of the first intermediate hopper 24 or the first supply hopper 25, for example.

The rotary kiln 61 is an activation device that activates the catalyst 14 prior to activation while agitating the catalyst 14. The rotary kiln 61 includes an inlet section 61A, a rotary body 61B, and a discharge section 61C. The rotary body 61B is a hollow cylindrical structure. The rotary body 61B is rotatable about its axis, for example, by application of rotational force from a motor (not shown). The inlet section 61A is coupled to a first end of the rotary body 61B. The interior of the inlet section 61A communicates with the interior of the rotary body 61B. A second end of the rotary body 61B is coupled to the discharge section 61C. The second end is the end of the rotary body 61B opposite the first end. The interior of the rotary body 61B communicates with the interior of the discharge section 61C. The discharge section 61C is coupled to the reactor 12 via the inlet pipe 15.

The rotary body 61B is slightly inclined so that the discharge section 61C is lower than the inlet section 61A.

The inlet section 61A introduces the feed gas supplied through a gas passage (not shown) into the interior of the rotary body 61B. The feed gas is a hydrocarbon gas. The inlet section 61A also introduces catalyst 14 prior to activation, supplied through a catalyst supply passage (not shown), into the interior of the rotary body 61B. The catalyst 14 introduced into the rotary body 61B is agitated by rotation of the rotary body 61B while being heated by a heating device (not shown). The catalyst 14 is activated by contacting the feed gas at a specified activation temperature for a specified period of time. The catalyst 14 inside the rotary body 61B moves from the first end toward the second end of the rotary body 61B as the rotary body 61B rotates, and eventually reaches the discharge section 61C. The catalyst 14 in the discharge section 61C is supplied into the reactor 12 through the hopper 62. The feed gas introduced into the rotary body 61B is supplied into the reactor 12 through the inlet pipe 15.

The present embodiment may be implemented in combination with the foregoing first embodiment. Specifically, the discharge section 61C may, for example, be coupled to the first receiving hopper 23 or to the first intermediate hopper 24. In such cases, the catalyst 14 within the discharge section 61C is supplied to the first receiving hopper 23 or the first intermediate hopper 24. In a case in which the discharge section 61C is connected to the first intermediate hopper 24, the hydrogen production device 10 may have a configuration in which the first receiving hopper 23 is omitted.

Further, the rotary kiln 61 does not necessarily need to form part of the first supply device 21. Specifically, the rotary kiln 61 may be provided independently of the first supply device 21. It is sufficient that the reactor 12 is configured to receive supply of the catalyst 14 activated within the rotary kiln 61.

### <Advantages of the Second Embodiment>

The second embodiment has the following advantages.
(2-1) The catalyst 14 is supplied, in an activated state, to the reactor 12. Since the activated catalyst 14 is supplied into the reactor 12, it is unnecessary to perform an activation process of the catalyst 14 inside the reactor 12. Accordingly, for example, during startup of the hydrogen production device 10, fusion of particles of the catalyst 14 due to temperature rise in the reactor 12 is suppressed. In addition, the stability of the flow of the catalyst 14 is ensured.
(2-2) The catalyst 14 is activated by being heated while agitated within the rotary kiln 61. As a result, fusion of particles of the catalyst 14 during activation process is suppressed. Thus, the catalyst 14 is supplied to the reactor 12 in a suitable state following activation.
(2-3) Furthermore, by supplying the catalyst 14 after activation to the reactor 12, the amount of catalyst 14 retained within the reactor 12 can be reduced. The reason for this is as follows. The catalyst 14 deactivates after a certain service life. While deactivated catalyst 14 is discharged from the reactor 12, catalyst 14 that has not yet deactivated is preferably retained within the reactor 12. In addition, the amount of the catalyst 14 in the reactor 12 should be controlled to be constant while continuously supplying the catalyst 14 into the reactor 12 and continuously discharging the catalyst 14 from the reactor 12. Accordingly, the amount of the catalyst 14 charged into the reactor 12 approximates the amount of the catalyst 14 discharged from the reactor 12. Thus, the amount of catalyst 14 retained in the reactor 12 is the same between a case in which a relatively small amount of catalyst 14 is supplied into the reactor 12 and a relatively small amount of catalyst 14 is discharged from the reactor 12 and a case in which a relatively large amount of catalyst 14 is supplied into the reactor 12 and a relatively large amount of catalyst 14 is discharged from the reactor 12. On the other hand, the amount of time that a particular portion of catalyst 14 remains inside the reactor 12 depends on the amount of catalyst 14 supplied into the reactor 12. For example, in a case in which a relatively large amount of catalyst 14 is supplied into the reactor 12 and a relatively large amount of catalyst 14 is discharged from the reactor 12, the time during which the catalyst 14 stays inside the reactor 12 is relatively short. In the case of catalyst 14 that has not been activated in advance, the time until deactivation, that is, the service life, becomes longer, necessitating retention of a correspondingly larger amount of catalyst 14 within the reactor 12. In contrast, by subjecting the catalyst 14 to pretreatment, the amount of catalyst 14 retained within the reactor 12 can be reduced, while enabling effective use of the service life of the catalyst 14. The pretreatment is the activation process.

### Other Embodiments

The above-described embodiments may be modified as follows.
In the first and second embodiments, the pressure of the reactor 12 may be maintained at atmospheric pressure. In this case, the hydrogen production device 10 may have a configuration in which the pressure vessel 11 is omitted. The lower the pressure of the reactor 12, the higher the methane conversion rate becomes.
In the first and second embodiments, when the pressure of the reactor 12 and the pressure of the first supply hopper 25 are equal, the catalyst 14 may be supplied to the reactor 12 by gravity feed as indicated by the arrow of a long-dash double-short-dash line in FIG. 1. When the pressure of the reactor 12 and the pressure of the second supply hopper 45 are equal, the fluidizing medium 17 may be supplied to the reactor 12 by gravity feed. The pressure may be, for example, atmospheric pressure. In this case, the first supply hopper 25 is connected to the upper portion of the reactor 12 through, for example, the third shutoff valve 28 and the first electric valve 29. The second supply hopper 45 is connected to the upper portion of the reactor 12 through the sixth shutoff valve 48 and the third electric valve 49. The same applies to the second embodiment.
In the first and second embodiments, the catalyst 14 may include fine metallic particles of nickel, cobalt, or the like, or fine metallic particles mainly composed of such metals.
The terms “tube” or “tubular” as used in the present description include any structure having a peripheral wall. For example, “tube” or “tubular” include but are not limited to any structure having circular cross-sectional shape, an elliptic cross-sectional shape, and a polygonal cross-sectional shape with sharp or rounded corners.
In the present description, whether the catalyst 14 is regarded as fresh is determined not by whether pretreatment has been performed, but by whether the catalyst 14 has already participated in the reaction. Fresh catalyst 14 refers to catalyst 14 that has not yet contributed to the reaction.

### Clauses

The hydrogen production device described in the present embodiment may be understood, for example, as follows.
1. A hydrogen production device according to a first aspect includes a reactor (12) that produces hydrogen by thermally decomposing a hydrocarbon gas, which is a feed gas, using a catalyst (14) including fine metallic particles, the feed gas being introduced into the reactor (12) through a lower portion of the reactor (12) such that a fluidized bed of the catalyst (14) is formed inside the reactor (12). Inert particles serving as a fluidizing medium (17) are mixed with the catalyst (14) to increase fluidity of the catalyst (14).

With the hydrogen production device according to the first aspect, by mixing the fluidizing medium with the catalyst, it is possible to suppress fusion of particles of the catalyst inside the reactor.
2. A hydrogen production device (10) according to a second aspect corresponds to the hydrogen production device (10) according to the first aspect, in which a pressure of the reactor (12) is higher than atmospheric pressure, the hydrogen production device (10) includes a first supply device (21) configured to supply fresh catalyst (14) to the reactor (12), a withdrawal device (31) configured to withdraw catalyst (14) having reduced activity from the reactor (12), and a second supply device (41) configured to supply the fluidizing medium (17) to the reactor (12). The first supply device (21) is configured to pressurize the fresh catalyst (14) to a pressure higher than or equal to the pressure of the reactor (12) and continuously carry the fresh catalyst (14) through pneumatic conveyance. The second supply device (41) is configured to pressurize the fluidizing medium (17) to a pressure higher than or equal to the pressure of the reactor (12) and continuously carry the fluidizing medium (17) through pneumatic conveyance.

With the hydrogen production device according to the second aspect, the first. supply device supplies fresh catalyst to the reactor through pneumatic conveyance, and the withdrawal device withdraws a catalyst having reduced activity from the reactor. Further, the fluidizing medium can be supplied to the reactor through pneumatic conveyance by the second supply device.
3. A hydrogen production device (10) according to a third aspect corresponds to the hydrogen production device (10) according to the second aspect, in which the first supply device (21) includes an activation device (61) configured to activate the catalyst prior to activation by heating the catalyst (14) while agitating the catalyst (14), and the first supply device (21) is configured to supply the catalyst (14) activated by the activation device (61) to the reactor (12).

With the hydrogen production device according to the third aspect, activated catalyst is supplied to the reactor. Accordingly, it is unnecessary to perform an activation process of catalyst inside the reactor. This prevents, for example, fusion of particles of the catalyst due to an increase in the temperature of the reactor at startup of the hydrogen production device. During the activation process, the catalyst is heated while being agitated. As a result, fusion of particles of the catalyst during activation process is suppressed.
4. A hydrogen production device (10) according to a fourth aspect corresponds to the hydrogen production device (10) according to the second or third aspect in which a carrier gas used for the pneumatic conveyance is the feed gas.

The hydrogen production device according to the fourth aspect is capable of supplying fresh catalyst and fluidizing medium to the reactor by using the flow of the feed gas.
5. A hydrogen production device (10) according to a fifth aspect corresponds to the hydrogen production device (10) according to the first aspect in which the fresh catalyst (14) and the fluidizing medium (17) are supplied to the reactor (12) by gravity feed.

According to the hydrogen production device of the fifth aspect, fresh catalyst and fluidizing medium are supplied to the reactor by gravity feed.
6. A hydrogen production device (10) according to a sixth aspect includes a first supply device (21) configured to supply the catalyst (14) to the reactor (12) by gravity feed, a withdrawal device (31) configured to withdraw catalyst (14) having reduced activity from the reactor (12), and a second supply device (41) configured to supply the fluidizing medium (17) to the reactor (12) by gravity feed, in which the first supply device (21) includes an activation device (61) configured to activate catalyst prior to activation by heating the catalyst (14) while agitating the catalyst (14), and the first supply device (21) is configured to supply the catalyst (14) activated by the activation device (61) to the reactor (12).

With the hydrogen production device according to the sixth aspect, activated catalyst is supplied to the reactor. Accordingly, it is unnecessary to perform an activation process of catalyst inside the reactor. This prevents, for example, fusion of particles of the catalyst due to an increase in the temperature of the reactor at startup of the hydrogen production device. During the activation process, the catalyst is heated while being agitated. As a result, fusion of particles of the catalyst during activation process is suppressed.

1. A hydrogen production device, comprising a reactor that produces hydrogen by thermally decomposing a hydrocarbon gas, which is a feed gas, using a catalyst including fine metallic particles, the feed gas being introduced into the reactor through a lower portion of the reactor such that a fluidized bed of the catalyst is formed inside the reactor,
wherein inert particles serving as a fluidizing medium are mixed with the catalyst to increase fluidity of the catalyst.

2. The hydrogen production device according to claim 1, wherein
a pressure of the reactor is higher than atmospheric pressure,
the hydrogen production device further comprises:
a first supply device configured to supply fresh catalyst to the reactor;
a withdrawal device configured to withdraw catalyst having reduced activity from the reactor; and
a second supply device configured to supply the fluidizing medium to the reactor,
the first supply device is configured to pressurize the fresh catalyst to a pressure higher than or equal to the pressure of the reactor and continuously carry the fresh catalyst through pneumatic conveyance, and
the second supply device is configured to pressurize the fluidizing medium to a pressure higher than or equal to the pressure of the reactor and continuously carry the fluidizing medium through pneumatic conveyance.

3. The hydrogen production device according to claim 2, wherein
the first supply device includes an activation device configured to activate the catalyst prior to activation by heating the catalyst while agitating the catalyst, and
the first supply device is configured to supply the catalyst activated by the activation device to the reactor.

4. The hydrogen production device according to claim 2, wherein a carrier gas used for the pneumatic conveyance is the feed gas.

5. The hydrogen production device according to claim 1, wherein the fresh catalyst and the fluidizing medium are supplied to the reactor by gravity feed.

6. The hydrogen production device according to claim 5, further comprising:
a first supply device configured to supply the catalyst to the reactor by gravity feed;
a withdrawal device configured to withdraw catalyst having reduced activity from the reactor: and
a second supply device configured to supply the fluidizing medium to the reactor by gravity feed, wherein
the first supply device includes an activation device configured to activate catalyst prior to activation by heating the catalyst while agitating the catalyst, and
the first supply device is configured to supply the catalyst activated by the activation device to the reactor.
